(19) United States
(12) Patent Application Publication
(10) Pub. No.: US 2017/0148058 A1
(43) Pub. Date: May 25, 2017

(54) USER REGISTRATION SYSTEM AND METHODS

(71) Applicant: MasterCard International Incorporated, Purchase, NY (US)

(72) Inventor: Rohit Chauhan, Somers, NY (US)

(21) Appl. No.: 14/946,202

(22) Filed: Nov. 19, 2015

(51) Int. Cl. G06Q 30/02; G06Q 30/00

(52) U.S. Cl. CPC G06Q 30/0258; G06Q 30/0268; G06Q 30/012

(57) ABSTRACT

As part of an online shopping process, a user's selection of offers, services, etc. is facilitated. A merchant's e-commerce server may form a composite display page that includes a display page section transmitted to the e-commerce server from a payment gateway in connection with an online purchase transaction. The display page section may include offer options selected or gathered by the payment gateway. The e-commerce server may serve the composite display page, including the offer options, to the customer in the online purchase transaction. The customer may easily select among the offer options, and may effect sign-up therefor without entering personal information to implement the offer, because that information has already been collected or become available during a checkout phase of the online purchase transaction.

### BACKGROUND

In many ways, the Internet is a highly effective way for retailers and other entities to reach prospective customers and other desired audiences. Through the results of user web searches and via online and other advertising, organizations of all kinds often attract individual users to websites maintained by the organizations.

It is frequently one goal of a website to collect the name and contact information of individual visitors to the website. Often the organization that maintains the website wishes to sell a product or services to the visitor, to commence an ongoing relationship and series of communications with the visitor, to enroll the visitor as a member, as a participant in a program, or as a recipient of a recurring service.

One drawback of public outreach via websites is that visitors often fail to engage in the process of entering their name, etc., in data entry forms provided on the websites. For many visitors, their interest in the offerings provided by the website may not be sufficient to motivate them to undertake the somewhat tedious task of data entry required to sign up for website offerings.

The present inventor has recognized an opportunity to decrease the burdens on individuals when it comes to signing up online for offers, services, memberships and the like.

### BRIEF DESCRIPTION OF THE DRAWINGS

Features and advantages of some embodiments of the present disclosure, and the manner in which the same are accomplished, will become more readily apparent upon consideration of the following detailed description of the disclosure taken in conjunction with the accompanying drawings, which illustrate preferred and exemplary embodiments and which are not necessarily drawn to scale, wherein:

FIG. 1 is a block diagram that illustrates a conventional system that handles online purchase transactions.

FIG. 2 is a block diagram of a user registration system provided according to some embodiments.

FIGS. 3 and 4 are block diagram representations of computers that may serve as components of the system shown in FIG. 2.

FIG. 5 is a flow chart that illustrates aspects of the present disclosure.

FIGS. 6 and 7 are example display page sections generated in accordance with aspects of the present disclosure.

FIG. 8 is an example composite display page generated in accordance with aspects of the present disclosure.

FIG. 9 is a flow chart that illustrates aspects of the present disclosure.

### DETAILED DESCRIPTION

In general, and for the purpose of introducing concepts of embodiments of the present disclosure, components of a payment/online purchasing system may also include capabilities for streamlining users' registration/sign-up for offers, services, membership etc. In some embodiments, an additional feature may be included in an online purchase transaction to leverage the information entry or access already available as part of the transaction activity. As part of the purchase transaction, one or more options to sign up/register for offers, services or the like may be presented to the customer. If the customer selects an offer or service, the already available information about the customer may be used to simplify the sign-up into a “one click” (or very few clicks) operation.

To facilitate this streamlining of the registration process, a merchant's payment gateway may supply to the merchant a display page section containing options for the customer to select one or more offers. The merchant may incorporate the display page section into a composite display page served from the merchant to the customer during the checkout portion of an online purchase transaction. If a customer indicates selection of one or more of the offers, the customer information may be supplied from the merchant to the payment gateway, which then may implement the customer sign-up for the selected offers using the customer information.

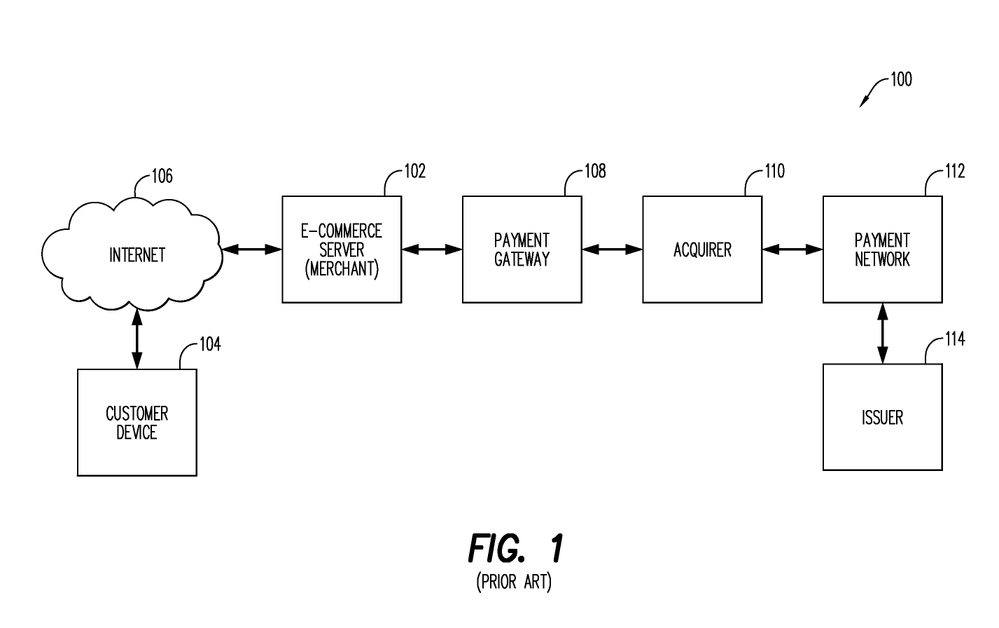

FIG. 1 is a block diagram that illustrates a conventional system 100 that handles online purchase transactions.

The system 100 includes an e-commerce server computer 102 that may be operated by or on behalf of an online merchant to permit online shopping transactions. For this purpose, as is well known, the e-commerce server computer 102 may host a shopping website, sometimes referred to as an “online store”. A customer (not shown) who operates a customer device 104 may access the shopping website by communicating over the Internet 106 with the e-commerce server computer 102. As is very well-known to those who are skilled in the art, the customer device 104 may be, for example, a personal computer or notebook computer that runs a browser program, a tablet computer or smartphone that runs a mobile browser and/or a suitable app, etc.

In some cases, especially for smaller merchants and/or those with less developed payment technology infrastructures, an entity known as a payment gateway (reference numeral 108) may serve as an intermediary between the e-commerce server computer 102 and the merchant's acquirer financial institution (“acquirer”), indicated by reference numeral 110. The acquirer 110 may receive an authorization request for an online purchase transaction from the payment gateway 108 (the latter acting for the merchant). The acquirer 110 may route the authorization request via a payment network 112 to a server computer 114 operated by the issuer of the payment card account that corresponds to a payment account number/payment token provided by the customer as part of the checkout process for the online purchase transaction. Also, the authorization response generated by the issuer server computer 114 may be routed back to the payment gateway 108 via the payment network 112 and the acquirer 110. The payment gateway 108 may confirm to the merchant (i.e., to the e-commerce server computer 102) that the transaction has been approved.

The payment network 112 may be, for example, the well-known Banknet® system operated by MasterCard International Incorporated, which is the assignee hereof.

The components of the system 100 as depicted in FIG. 1 are only those that are needed for processing a single transaction. Those who are skilled in the art will recognize that in the real world, online shopping and payment systems may process many purchase transactions (including simultaneous transactions) and may include a considerable number of payment account issuers and their computers, a considerable number of acquirers and their computers, and numerous merchants and their e-commerce servers. There also may be more than one entity that serves as a payment gateway. Typically, a payment gateway may provide payment services for numerous merchants. The system may also include a very large number of customers/online shoppers, who hold payment accounts that they use for their online shopping activities. It is also well known that elements of the system 100 (e.g., acquirers, the payment network, payment account issuers) may play similar roles in connection with in-store purchase transactions and in other types of transactions.

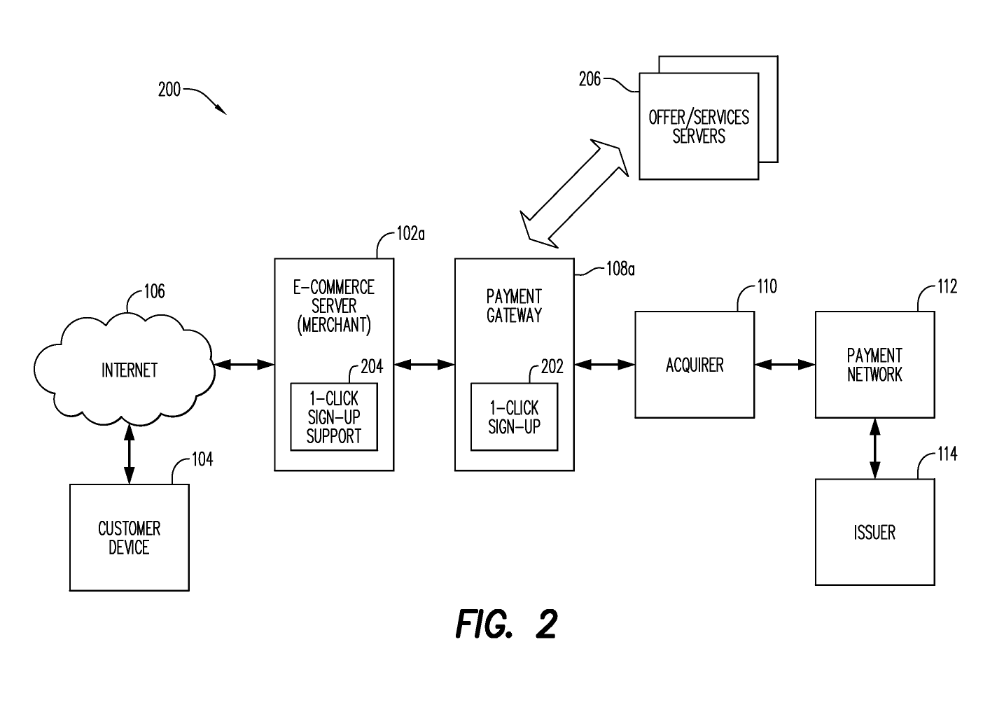

FIG. 2 is a block diagram of a user registration system 200 provided according to some embodiments. In some embodiments, the system 200 may overlap in a number of ways with the conventional online shopping/payment system 100 shown in FIG. 1. For example, the account issuer 114, the payment network 112 and the acquirer 110 may play roles in the system 200 that are essentially the same as in the system 100. However, in accordance with teachings of this disclosure, the payment gateway (reference numeral 108a in FIG. 2) and the e-commerce server computer (reference numeral 102a in FIG. 2) may have capabilities and functions beyond those of conventional components of those types. In addition, the e-commerce server computer 102a and the payment gateway 108a may have some or all of the functions and capabilities typically associated with such components.

In FIG. 2, the additional capabilities/functionality of the payment gateway 108a are represented by a block 202, and—as described below—may relate to processing that facilitates streamlined sign-up by users for offers/services. Block 204, associated with e-commerce server computer 102a, represents additional capabilities/functionality of the latter, relating to cooperation with the payment gateway 108a to facilitate streamlined sign-up services.

Blocks 206 represent a number of server computers, possibly remote from the payment gateway 108a. The payment gateway 108a may cooperate with the server computers 206 to receive information regarding offers, services, etc. to be presented to the customers that visit the website hosted by the e-commerce server computer 102a. The payment gateway 108a may also cooperate with the server computers 206 to implement registration/sign-up by customers who indicate their selection of offers, services, etc., as described below. The servers 206 may hereinafter be referred to as “offer servers” or “offer source servers.”

It will be noted that the system 200 is also shown as including the Internet 106 and the customer device 104, as mentioned above in connection with FIG. 1. Because of enhanced functionality offered by the website hosted by the e-commerce server computer 102a, the customer (not shown) may be presented with additional options for selection via the customer device 104 beyond what occurs in a typical online shopping transaction. Examples of such additional options will be described below.

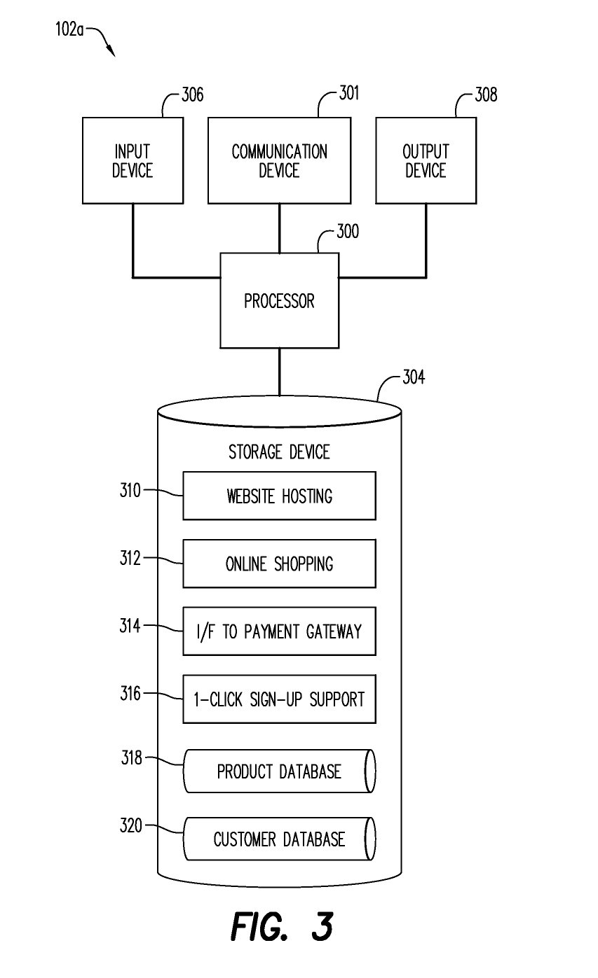

FIG. 3 is a block diagram that illustrates an embodiment of the e-commerce server computer 102a.

The e-commerce server computer 102a may, in its hardware aspects, be like a typical e-commerce server, but may be controlled by software to cause it to function as described herein.

The e-commerce server computer 102a may include a processor 300 operatively coupled to a communication device 301, a storage device 304, an input device 306 and an output device 308. The communication device 301, the storage device 304, the input device 306 and the output device 308 may all be in communication with the processor 300.

The processor 300 may be constituted by one or more processors. The processor 300 may operate to execute processor-executable steps, contained in program instructions described below, so as to control the e-commerce server computer 102a to provide desired functionality.

Communication device 301 may be used to facilitate communication with, for example, other devices (such as a computer—described below—operated by the payment gateway 108a; computers, smart phones and the like operated by customers). For example, communication device 301 may comprise numerous communication ports (not separately shown), to allow the e-commerce server computer 102a to communicate simultaneously with a number of other computers and other devices, including communications as required to simultaneously handle numerous online shopping visits and transactions.

Input device 306 may comprise one or more of any type of peripheral device typically used to input data into a computer. For example, the input device 306 may include a keyboard and a mouse. Output device 308 may comprise, for example, a display and/or a printer.

Storage device 304 may comprise any appropriate information storage device, including combinations of magnetic storage devices (e.g., hard disk drives), optical storage devices such as CDs and/or DVDs, and/or semiconductor memory devices, such as Random Access Memory (RAM) devices and Read Only Memory (ROM) devices, as well as so-called flash memory. Any one or more of such information storage devices may be considered to be a computer-readable storage medium or a computer usable medium or a memory.

Storage device 304 stores one or more programs for controlling processor 300. The programs comprise program instructions (which may be referred to as computer readable program code means) that contain processor-executable process steps of the e-commerce server computer 102a, executed by the processor 300 to cause the e-commerce server computer 102a to function as described herein.

The programs may include one or more conventional operating systems (not shown) that control the processor 300 so as to manage and coordinate activities and sharing of resources in the e-commerce server computer 102a, and to serve as a host for application programs (described below) that run on the e-commerce server computer 102a.

The programs stored in the storage device 304 may also include a website hosting application program 310 that controls the processor 300 to enable the e-commerce server computer 102a to host the online shopping website referred to above.

Another program that may be stored in the storage device 304 is an online shopping application program 312 that controls the processor 300 to enable and handle the shopping visits, product selection and checkout operations required for online purchase transactions to occur on the online shopping website.

Still further, the storage device 304 may store software (reference numeral 314) that serves as an interface for the interactions of the e-commerce server computer 102a with the payment gateway 108a. In addition, the storage device 304 may store a software module or add-on 316 that programs the e-commerce server computer 102a to provide functionality relating to streamlined user sign-up for offers, services, etc., as described in more detail below. Although the software module 316 is shown as separate from the online shopping application program 312, in practice it may be implemented as a modification or upgrade of the online shopping application program 312.

The storage device 304 may also store, and the e-commerce server computer 102a may also execute, other programs, which are not shown. For example, such programs may include a reporting application, which may respond to requests from system administrators for reports on the activities performed by the e-commerce server computer 102a. The other programs may also include, e.g., device drivers, database management programs, etc.

The storage device 304 may also store one or more databases required for operation of the e-commerce server computer 102a, including, for example, a product database 318 and a customer database 320. The product database 318 may store data concerning product items available for purchase via the e-commerce server computer 102a. The customer database 320 may store data relating to current and/or past customers who have engaged in purchase transactions via the e-commerce server computer 102a.

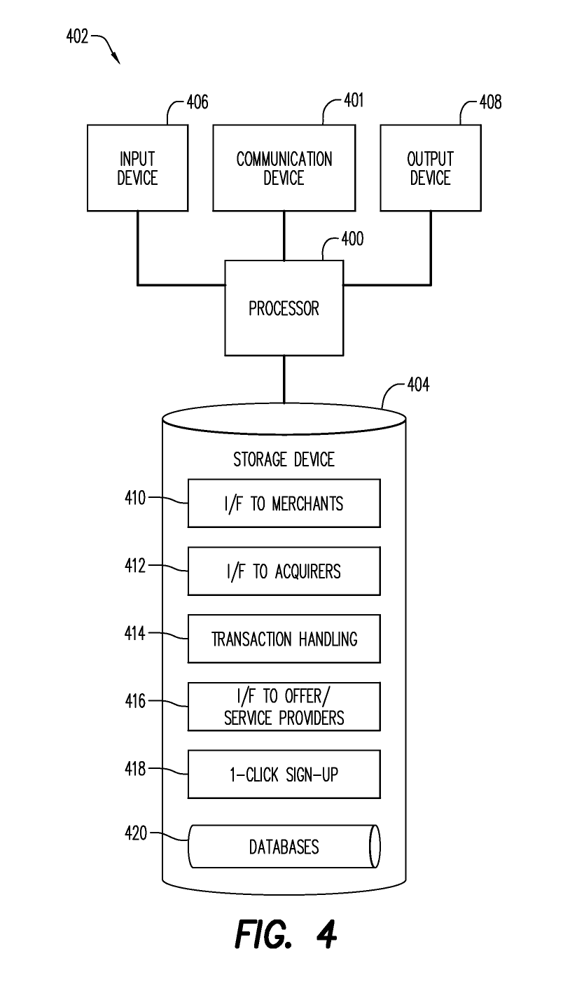

FIG. 4 is a block diagram of a payment gateway computer 402 that may be operated by the payment gateway 108a to perform the payment gateway functions described herein. Moreover, the functionality provided by the payment gateway computer 402 may also include features that promote streamlined sign-ups for offers, services, etc.

In its hardware architecture and components, the payment gateway computer 402 may, for example, resemble the hardware architecture and components described above in connection with FIG. 3. However, the payment gateway computer 402 may be programmed somewhat differently from the e-commerce server computer 102a so as to provide different functionality.

Returning again to the hardware aspects of the payment gateway computer 402, it may include a processor 400, a communication device 401, a storage device 404, an input device 406 and an output device 408. The communication device 401, the storage device 404, the input device 406 and the output device 408 may all be in communication with the processor 400.

The above descriptions of the hardware components shown in FIG. 3 may, in some embodiments, also be applicable to the like-named components shown in FIG. 4.

Storage device 404 stores one or more programs for controlling processor 400. The programs comprise program instructions (which may be referred to as computer readable program code means) that contain processor-executable process steps of the payment gateway computer 402, executed by the processor 400 to cause the payment gateway computer 402 to function as described herein.

The programs may include one or more conventional operating systems (not shown) that control the processor 400 so as to manage and coordinate activities and sharing of resources in the payment gateway computer 402, and to serve as a host for application programs (described below) that run on the payment gateway computer 402.

The storage device 404 may also store software 410 that serves as an interface between the payment gateway computer 402 and the respective computers (not shown apart from e-commerce server computer 102a) operated by the merchants served by the payment gateway 108a.

In addition, the storage device 404 may store software 412 that serves as an interface between the payment gateway computer 402 and the merchants' acquirers, which are represented by the single acquirer 110 shown in FIG. 2.

Further, the storage device 404 may store a transaction handling application program 414. The application handling application program 414 may program the payment gateway computer 402 to provide functionality typically associated with handling of payment account transactions by payment gateways.

Still further, the storage device 404 may store software 416 that serves as an interface between the payment gateway computer 402 and the server computers 206 shown in FIG. 2. It will be recollected that the server computers 206 may provide information regarding offers, services, etc. to be presented to the customers that visit the website hosted by the e-commerce server computer 102a. The server computers 206 may also complete the implementation of registration/sign-up by customers who indicate their selection of offers, services, etc., that were presented to the customers.

Moreover, and in accordance with teachings of the present disclosure, the storage device 404 may store a software module or component 418. The software module 418 may program the payment gateway computer 402 to provide the functionality relating to streamlining user registration/sign-up, as described in more detail below.

The storage device 404 may also store, and the payment gateway computer 402 may also execute, other programs, which are not shown. For example, such programs may include a reporting application, which may respond to requests from system administrators for reports on the activities performed by the payment gateway computer 402. The other programs may also include, e.g., device drivers, database management programs, etc.

The storage device 404 may also store one or more databases (reference numeral 420) required for operation of the payment gateway computer 402.

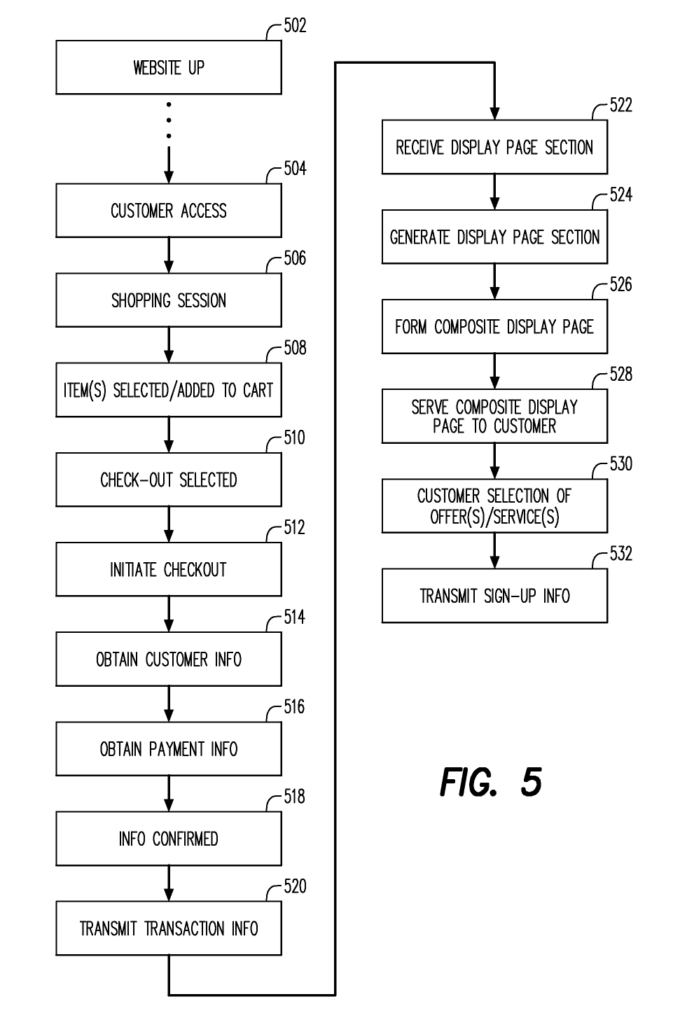

FIG. 5 is a flow chart that illustrates aspects of the present disclosure, including a portion of the operations of the e-commerce server computer 102a.

As indicated at 502 in FIG. 5, it is assumed for purposes of the following description that the e-commerce server computer 102a has been fully programmed, loaded with product data and configured such that it is actively available to host visits to the above-mentioned online shopping website. At some point in time thereafter, as indicated at 504, a customer/user may access the website via the Internet to initiate an online shopping session (block 506). As is customary, the customer may navigate through the website, viewing images and information about products available for sale via the website. In some embodiments, this may occur after the customer has signed in as a returning customer.

It is assumed that the customer's visit to the online shopping website is a success in that the customer selects one or more items for purchase, as indicated at block 508. In many cases, the customer may indicate selection of the product for purchase by clicking on an “add to cart” button presented in the current webpage (not shown) in which the product image and information (e.g., description and price, etc.) are displayed.

It is next assumed, as indicated at 510, that the user indicates that his/her selection of products is complete by selecting a “checkout” option presented on the current display page. In response to this indication, the e-commerce server computer 102a may initiate (block 512) a checkout phase of operations for the online shopping session.

As part of the checkout phase of operations, as indicated at 514, the e-commerce server computer 102a may obtain from the customer information concerning the customer, such as the customer's name and contact information (e.g., mailing address, email address, phone number, etc.). In some situations, this may be done by prompting the customer to fill in a suitable data entry form served to the customer from the e-commerce server computer 102a as part of the checkout phase of operations. The customer may fill in the customer information character-by-character by operating a keyboard or the like on the customer device 104 (FIG. 2). In other situations, the customer information may be at least partially filled into the data entry form by an auto-fill process. For example, the customer device's browser program may store customer information and may include an auto-fill utility to streamline use of the browser for online shopping checkout. In other situations, where the customer is a returning customer and has signed in as such for the current visit, the e-commerce server computer 102a may retrieve the customer information from the customer database 320 (FIG. 3). Or, the e-commerce server computer 102a may have previously retrieved the customer information at the outset of the online shopping session when the customer signed in as a returning customer. In either case, the e-commerce server computer 102a may auto-fill the customer information into the data entry form, and may then obtain the customer's confirmation that the customer information is correct and current.

At 516, the e-commerce server computer 102a may obtain payment information for the online shopping transaction. For example, in some situations, the e-commerce server computer 102a may prompt the customer to fill in a data entry form so as to provide a payment account number, name on the account, expiration date, security code, etc. The customer may fill in the payment information character-by-character by operating a keyboard or the like, as mentioned above. In other situations, the e-commerce server computer 102a may have a “card on file” for the customer, and may offer to the customer an opportunity to utilize the card on file information as the payment information for the current online purchase transaction. Thus, for example, the e-commerce server computer 102a may retrieve the card on file information from the customer database 320, and an auto-fill of the payment information data entry form may follow.

It may also be the case that the e-commerce server computer 102a obtains confirmation (block 518) from the customer that the payment information and/or other information is correct. For example, the ship-to address may be confirmed along with other information that has been collected or gathered during the checkout phase of operations.

At 520, the e-commerce server computer 102a may transmit information to the payment gateway 108a relating to the current online purchase transaction. For example, in some embodiments, the transaction information transmitted at 520 may include typical data items transmitted from a merchant to a payment gateway in connection with an online purchase transaction. In some embodiments, the transmitted information may include additional information about the customer, such as information from a customer profile and/or demographic information that the e-commerce server computer 102a may have available from the customer database 320 and/or from other sources. In addition or alternatively, the information provided from the e-commerce server computer 102a to the payment gateway 108 may include information concerning the products selected for purchase in the current online shopping transaction.

At 522, the e-commerce server computer 102a may receive, from the payment gateway 108a, and in accordance with aspects of the present disclosure, a display page section that is to be processed and utilized by the e-commerce server computer 102a in a manner described below.

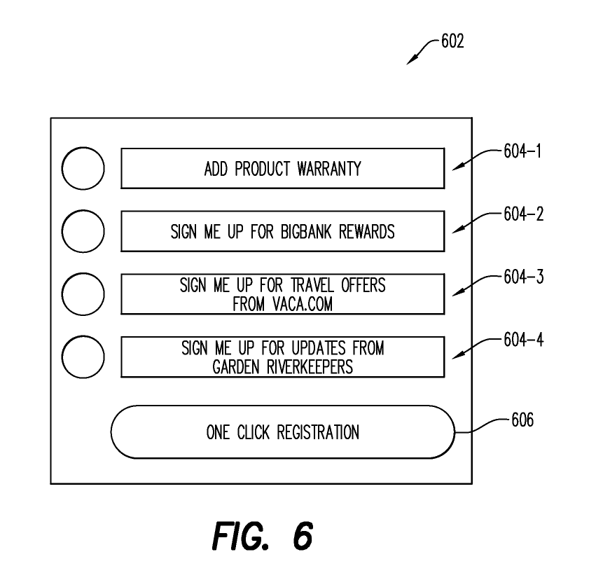

FIG. 6 is an example version of the type of display page section that the e-commerce server computer 102a may receive as referred to above in connection with block 522. In FIG. 6, reference numeral 602 generally indicates the display page section shown in the drawing.

As seen from FIG. 6, the display page section 602 may include a number of options that (as will be seen) will be selectable by the customer. These may be options for offers (including product warranties), services, subscriptions, memberships, etc., and are indicated by reference numerals 604-1, 604-2, 604-3, 604-4 in FIG. 6. In addition, the display page section 602 may include a confirm/register/sign-up button 606 that—as will be seen—will be actuatable by the customer in a later stage of the process of FIG. 5. The options 604 presented in the display page section 602 may represent offers, services, etc., gathered/received by the payment gateway 108a (FIG. 2) from the various offer servers 206. As will be seen, the payment gateway 108a may have selected offers/services, etc. for inclusion in the display page section 602 according to a pre-determined algorithm and/or based on customer/demographic information and/or other information provided by the e-commerce server computer 102a.

In some situations, the display page section 602 may include a different number of options other than the four options illustrated in the drawing. For example, only one or two options may be presented in some situations.

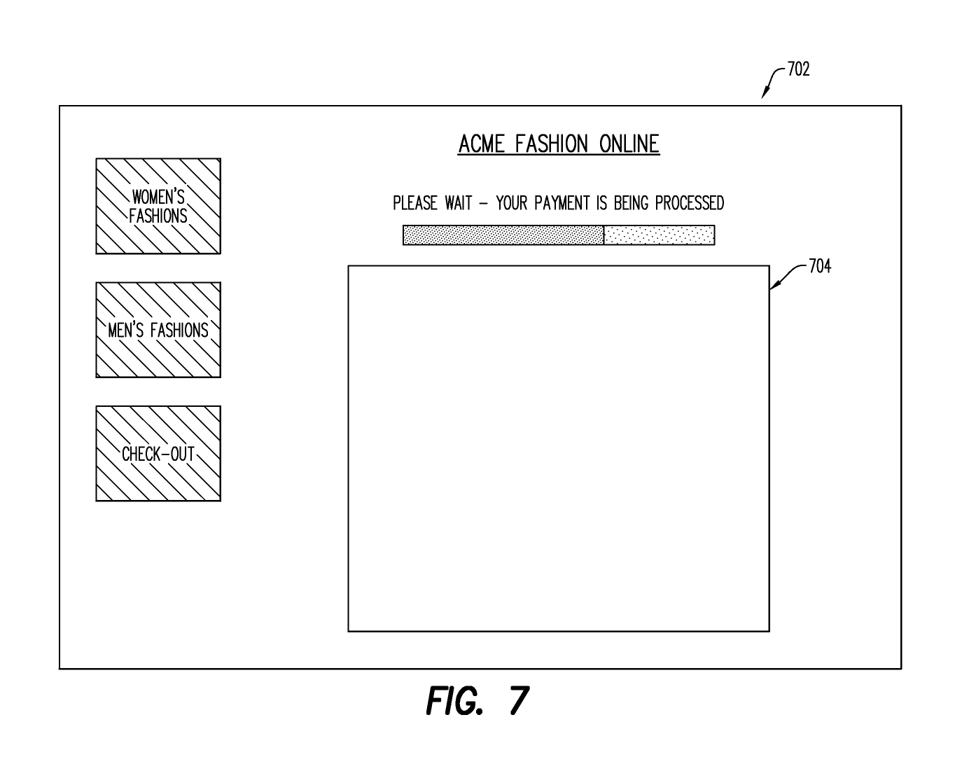

Referring again to FIG. 5, at 524, the e-commerce server computer 102a may generate a display page section such as, for example, the display page section 702 shown in FIG. 7. It will be noted that in the example display page section 702 of FIG. 7, there is a locus 704, at which the display page section 602 may be inserted. Alternatively, in some embodiments of the display page section 702, simply a full page of image may be provided, with no empty locus 704, such that the display page section 602 may later simply be pasted over a portion of the display page section 702.

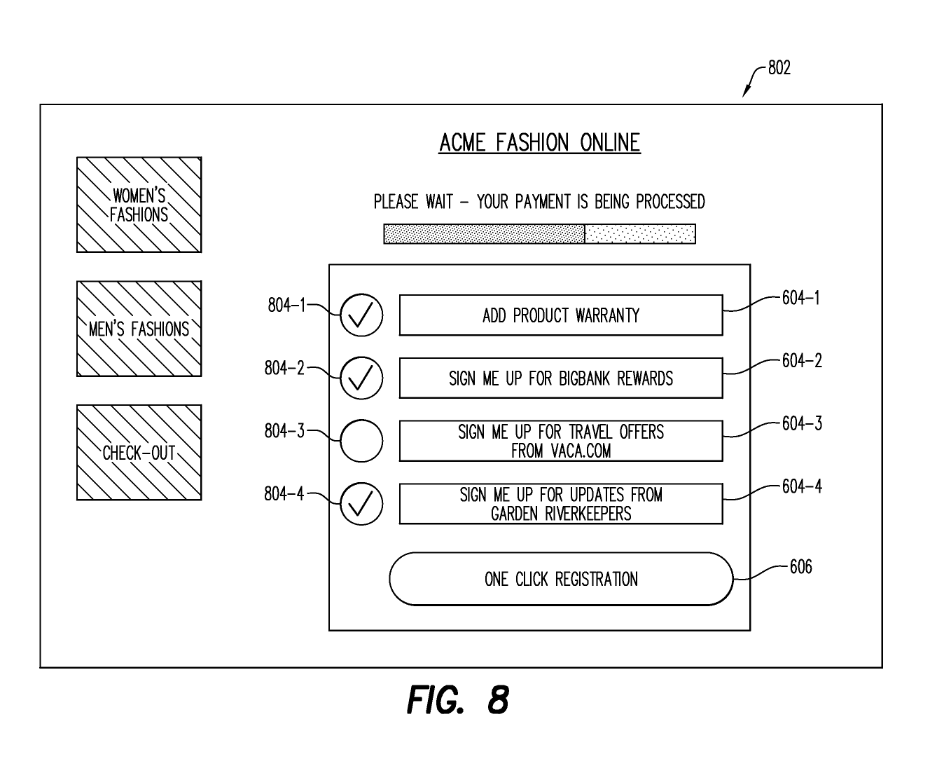

At 526 in FIG. 5, the e-commerce server computer 102a may form a composite display page, of which an example is shown in FIG. 8. It will be noted that the composite display page (reference numeral 802) is formed from the display page sections 602 and 702 referred to above. In some embodiments, the display page section 602 may be included in the composite display page 802 as a pop-up page element. At 528, the e-commerce server computer 102a may serve the composite display page 802 to the customer device 104 (FIG. 2). At 530 in FIG. 5, the customer may select among the options 604-1, 604-2, 604-3 and 604-4 provided in the composite display page 802, and may indicate such selection(s) to the e-commerce server computer 102a.

It is to be noted that the composite display page 802 is presented in FIG. 8 in a condition such that it reflects selections of offers/services by the customer. Thus, the composite display page 802, in the condition as initially served to the customer, may be different in that it may not reflect any selection of offers/services. In the condition of composite display page 802 as seen in FIG. 8, it is indicated (by checkmarks in selection elements 804-1, 804-2 and 804-4), that the customer has selected options 604-1, 604-2, 604-4, which are respectively associated with elements 804-1, 804-2, 804-4. The selection element 804-3 has gone unchecked, indicating that the customer has not selected the associated option 604-3. The customer may complete selection of the desired options by actuating button 606.

Referring again to FIG. 5, at 532, the e-commerce server computer 102a may transmit to the payment gateway 108a information that indicates what offers/services were selected by the customer at 530. The information transmitted at 532 may also include the customer's name and required contact information, at least to the extent that such information had not previously been transmitted from the e-commerce server computer 102a to the payment gateway 108a.

Accordingly, it will be recognized that—via the process of FIG. 5—the e-commerce server computer 102a has provided to the payment gateway 108a all of the information that may be required for the customer to sign up/register for one or more offers, services or the like that were presented to the customer at 528. Moreover, since the customer's name and contact information had already been gathered/obtained either before or in connection with the checkout phase of operations, the customer's sign-up for the offers/services only required one or two or a few clicks on options/buttons, and did not require the customer to enter his/her name or contact information in connection with sign-up/registration. Accordingly, the user's sign-up was streamlined and made quite simple and nearly effortless, which in many circumstances may help lead to an increased uptake of offers, and a highly effective way for the sponsors of the offers to achieve engagement with their desired audience and/or prospective customers.

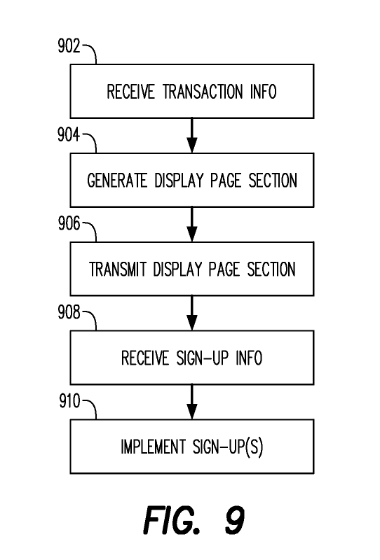

FIG. 9 is a flow chart that illustrates aspects of the present disclosure, including a portion of the operations of the payment gateway 108a.

At 902 in FIG. 9, the payment gateway 108a may receive the transaction information transmitted by the e-commerce server computer 102a as discussed above in connection with block 520 in FIG. 5.

At 904, the payment gateway 108a may generate a display page section such as that illustrated in FIG. 6. In doing so, for example, the payment gateway 108a may select among a number of offers, etc., for which the payment gateway 108a had received qualifying information from the offer servers 206 (FIG. 2). In some embodiments, the payment gateway 108a may apply an algorithm for selecting among the available offers to determine which offers to include in the display page section. In some embodiments, the algorithm may take into consideration information about the customer and/or the current purchase transaction that the payment gateway 108a had received from the e-commerce server computer 102a. In some embodiments, the algorithm/offer selection process may be designed to maximize the likelihood of uptake from the customer and/or the potential promotional income that the payment gateway 108a may realize from sponsors of the offers. In some embodiments, the income to be realized by the payment gateway 108a from sponsors of offers may depend at least in part on whether particular offers are selected for sign-up/registration by the customer.

In some embodiments, the algorithm may take into consideration the identity of the merchant that submitted the current purchase transaction (i.e., the proprietor of the online shopping website) and may select and/or exclude offers based on the identity of the merchant and/or may screen out offers that are not consistent with the merchant's goals.

At 906, the payment gateway 108a may transmit a display page section (such as the example shown in FIG. 6) to the e-commerce server computer 102a. At 908, the payment gateway 108a may receive from the e-commerce server computer 102a the offer selection/sign-up information transmitted by the e-commerce server computer 102a, as discussed above in connection with block 532 in FIG. 5. Thus, as noted above, the payment gateway 108a may now have received all information required to implement the customer's sign-up for an offer, a service, etc. that the customer has selected.

At 910, the payment gateway 108a may communicate with one or more of the offer servers 206 to cause the indicated sign-up/registration to be implemented. For example, where the offer is that the customer sign-up for future e-mail updates from a sponsoring organization, the payment gateway 108a may transmit the customer's name and/or e-mail address to one of the offer servers 206 that is acting on behalf of the organization in question. That particular offer server may then cause the email address in question to be added to the appropriate e-mail mailing list of the organization. For other types of offers, other suitable processes may be employed, including action by the relevant offer server 206 in response to customer information supplied by the payment gateway 108a.

It will be appreciated that one or more of the offer servers 206 may have the same type of hardware architecture and/or components as the computer described above in connection with FIG. 3. It will also be understood that the customer device 104 may include, among other components, a processor/mobile processor and a program memory in communication therewith containing software (including a browser, e.g.), to control the customer device processor. The customer device may also include hardware and software components to implement a user interface by which the customer may take the actions ascribed to him/her in the above description of FIGS. 5 & 8.

As used herein and in the appended claims, the term “computer” should be understood to encompass a single computer or two or more computers in communication with each other.

As used herein and in the appended claims, the term “processor” should be understood to encompass a single processor or two or more processors in communication with each other.

As used herein and in the appended claims, the term “memory” should be understood to encompass a single memory or storage device or two or more memories or storage devices.

As used herein and in the appended claims, a “server” includes a computer device or system that responds to numerous of requests for service from other devices.

The flow charts and descriptions thereof herein should not be understood to prescribe a fixed order of performing the method steps described therein. Rather the method steps may be performed in any order that is practicable, including simultaneous performance of steps.

As used herein and in the appended claims, the term “payment card system account” includes a credit card account, a deposit account that the account holder may access using a debit card, a prepaid card account, or any other type of account from which payment transactions may be consummated. The terms “payment card system account” and “payment card account” and “payment account” are used interchangeably herein. The term “payment card account number” includes a number that identifies a payment card system account or a number carried by a payment card, or a number that is used to route a transaction in a payment system that handles debit card and/or credit card transactions. The term “payment card” includes a credit card, debit card, prepaid card, or other type of payment instrument, whether an actual physical card or virtual, e.g., as part of an electronic wallet.

As used herein and in the appended claims, the term “payment card system” refers to a system for handling purchase transactions and related transactions. An example of such a system is the one operated by MasterCard International Incorporated, the assignee of the present disclosure. In some embodiments, the term “payment card system” may be limited to systems in which member financial institutions issue payment card accounts to individuals, businesses and/or other organizations.

Although the present disclosure has been described in connection with specific exemplary embodiments, it should be understood that various changes, substitutions, and alterations apparent to those skilled in the art can be made to the disclosed embodiments without departing from the spirit and scope of the disclosure as set forth in the appended claims.

What is claimed is:

1. A method comprising:
hosting an online shopping website on a computer;
allowing a customer to access the online shopping website;
receiving from the customer at least one selection of an item for purchase;
receiving a first indication from the customer that the customer wishes to enter a checkout phase of operations;
initiating the checkout phase of operations with respect to the at least one selected item for purchase;
obtaining, in connection with the initiated checkout phase of operations, the customer's name and contact information;
transmitting purchase transaction information from the computer to a payment gateway;
receiving, in the computer, from the payment gateway, a first display page section, the first display page section including at least one option for the customer to select an offer and/or a service not related to the checkout phase of operations;
generating, in the computer, a second display page section related to the checkout phase of operations;
forming, in the computer, a composite display page formed from the received first display page section and the second display page section;
serving the composite display page from the computer to the customer;
receiving, from the customer, a second indication that the customer has selected at least one of said at least one option included in the first display page section; and
transmitting, from the computer to the payment gateway, (a) said second indication; and (b) the customer's name and contact information.

2. The method of claim 1, wherein the customer inputs the customer's name and contact information by entering characters in an online form provided by the online shopping website.

3. The method of claim 1, wherein the customer's name and contact information are provided via an auto-fill operation with respect to an online form provided by the online shopping website.

4. The method of claim 1, wherein:
the computer has the customer's contact information on file prior to said allowing step; and
said obtaining step includes the computer retrieving the customer's contact information from a storage device.

5. The method of claim 1, wherein the customer's contact information provided to the payment gateway includes the customer's email address and/or telephone number.

6. The method of claim 1, wherein the first display page section is presented as a pop-up page element in the composite display page.

7. The method of claim 1, wherein the at least one option includes a product warranty offer.

8. A method comprising:
receiving, in a payment gateway computer, from a merchant, purchase transaction information for an online shopping transaction initiated by a customer;
responding, by the payment gateway computer, to receiving the purchase transaction information, by generating and transmitting to the merchant a first display page section, the first display page section including at least one option for the customer to select an offer and/or a service; the first display page section for inclusion in a composite display page to be served to the customer by the merchant;
receiving, by the payment gateway computer, from the merchant, an indication that the customer has selected at least one of said at least one option included in the first display page section; and
implementing, by the payment gateway computer, the customer's enrollment for the selected at least one offer and/or service.

9. The method of claim 8, wherein said implementing step includes using customer contact information provided to the payment gateway computer as part of the purchase transaction information received from the merchant.

10. The method of claim 9, wherein the customer contact information includes the customer's name and mailing address.

11. The method of claim 8, wherein said implementing includes using customer contact information provided by the merchant to the payment gateway apart from the purchase transaction information.

12. The method of claim 11, wherein the customer contact information includes at least one of an email address and a telephone number.

13. The method of claim 8, wherein said selected at least one offer includes a product warranty.

14. An apparatus comprising:
a processor; and
a memory in communication with the processor and storing program instructions, the processor operative with the program instructions to perform functions as follows:
hosting an online shopping website on a computer;
allowing a customer to access the online shopping website;
receiving from the customer at least one selection of an item for purchase;
receiving a first indication from the customer that the customer wishes to enter a checkout phase of operations;
initiating the checkout phase of operations with respect to the at least one selected item for purchase;
obtaining, in connection with the initiated checkout phase of operations, the customer's name and contact information;
transmitting purchase transaction information from the computer to a payment gateway;
receiving, in the computer, from the payment gateway, a first display page section, the first display page section including at least one option for the customer to select an offer and/or a service not related to the checkout phase of operations;
generating, in the computer, a second display page section related to the checkout phase of operations;
forming, in the computer, a composite display page formed from the received first display page section and the second display page section;
serving the composite display page from the computer to the customer;
receiving, from the customer, a second indication that the customer has selected at least one of said at least one option included in the first display page section; and
transmitting, from the computer to the payment gateway, (a) said second indication; and (b) the customer's name and contact information.

15. The apparatus of claim 14, wherein the customer inputs the customer's name and contact information by entering characters in an online form provided by the online shopping website.

16. The apparatus of claim 14, wherein the customer's name and contact information are provided via an auto-fill operation with respect to an online form provided by the online shopping website.

17. The apparatus of claim 14, wherein:
the computer has the customer's contact information on file prior to said allowing step; and
said obtaining step includes the computer retrieving the customer's contact information from a storage device.

18. The apparatus of claim 14, wherein the customer's contact information provided to the payment gateway includes the customer's email address and/or telephone number.

19. The apparatus of claim 14, wherein the first display page section is presented as a pop-up page element in the composite display page.

20. The apparatus of claim 14, wherein the at least one option includes a product warranty offer.
